(19) United States
(12) Patent Application Publication
(10) Pub. No.: US 2020/0189484 A1
(43) Pub. Date: Jun. 18, 2020

(54) VARIABLE HEAD LINING APPARATUS

(71) Applicants: HYUNDAI MOTOR COMPANY, Seoul (KR); KIA MOTORS CORPORATION, Seoul (KR)

(72) Inventor: Ja-Hae Choi, Busan (KR)

(21) Appl. No.: 16/686,616

(22) Filed: Nov. 18, 2019

(30) Foreign Application Priority Data
Dec. 12, 2018 (KR) 10-2018-0159902

(51) Int. Cl. B60R 11/02; B60J 7/04; B60J 7/00; B60R 11/00

(52) U.S. Cl. CPC B60R 11/0235; B60J 7/04; B60R 2011/0028; B60R 11/00; B60K 2370/80; B60J 7/003

(57) ABSTRACT

A variable head lining apparatus may include a roof portion including a rail structure and entirely exposable to an internal of a vehicle; and a variable roof portion configured to partially cover the roof portion by slidably operating along the rail structure.

### CROSS-REFERENCE TO RELATED APPLICATION

The present application claims priority to Korean Patent Application No. 10-2018-0159902, filed on Dec. 12, 2018, the entire contents of which is incorporated herein for all purposes by this reference.

### BACKGROUND OF THE DISCLOSURE

### Field of the Disclosure

The present invention relates to a head lining apparatus embedded in the ceiling of a vehicle.

### Description of Related Art

There is a trend that a function of the vehicle is changed in such a direction as to increase the activities that a user can perform in the internal thereof according to development of an autonomous vehicle.

That is, a structure of the vehicle internal is changed into a variously variable structure, and a vehicle seat is conventionally moved only in the defined section with the concept such as a first row, a second row, a third row, and a fourth row, but upon autonomous traveling, the entire seat may be moved from the front to the rear thereof, etc.

As such, a roof of the vehicle is entirely changed to a transparent glass, a door or the roof, etc. is changed to a fully open type, and the time during which a vehicle owner does not operate within the vehicle is lengthened, increasing functions of the internal utilities.

However, it is currently impossible to correspond to the roof structure of a future vehicle with the conventional fixed shape as a portion for covering a vehicle body.

That is, the entire roof is formed of a glass and mobility of the seat is important, but the conventional head lining does not match thereto.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a head lining apparatus configured for a vehicle which is variable corresponding to a change in the structure of a roof or a seat of a vehicle.

A variable head lining apparatus according to various aspects of the present invention may include a roof portion including a rail structure and entirely exposable to an internal of a vehicle and a variable roof portion configured to partially cover the roof portion by slidably operating along the rail structure.

As such, the variable head lining apparatus can further include a motor configured for driving the variable roof portion and a control portion for controlling the motor.

Furthermore, the variable roof portion slidably operates by a roller coupled to the rail structure.

As such, the control portion controls the motor by interlocking with the positional movement of a seat by recognizing the positional movement of the seat in a vehicle.

Herein, the variable roof portion may include glass or an internal trim portion.

Meanwhile, the variable roof portion may include a display for displaying an input signal provided from an image providing apparatus.

As such, the display rotatably operates downwardly based on one side of the front or the rear thereof based on the roof portion.

Furthermore, the variable head lining apparatus can further include a hinge motor configured for rotatably operating the display, a cable for limiting the rotation angle of the display, and a cable motor configured for selectively driving the cable.

Furthermore, a rail of the rail structure is formed to be dual as the upper side and the lower side thereof, the variable head lining apparatus may further include a display for slidably operating along one side rail of the upper side rail and the lower side rail, and displaying an input signal provided from an image providing apparatus, and the variable roof portion slidably operates along the other side rail of the upper side rail and the lower side rail.

As such, the variable roof portion slidably operates by interlocking with the positional movement of a seat in the vehicle.

Meanwhile, the variable roof portion is configured in a roll type, and can extend the area configured for covering the roof portion by slidably operating along the rail structure.

Next, a variable head lining apparatus according to another aspect of the present invention may include a roof portion including a rail structure and entirely exposable to an internal of a vehicle, a fixing rod and a sliding rod for slidably operating along the rail structure, and a screen wound around the fixing rod and the sliding rod, and the fixing rod and the sliding rod are operable independently.

As such, a rail of the rail structure is formed to be dual as the upper side and the lower side thereof, the screen slidably operates along one side rail of the upper side rail and the lower side rail, and the variable head lining apparatus can further include a display for slidably operating along the other side rail of the upper side rail and the lower side rail, and displaying an input signal provided from an image providing apparatus.

Herein, the display rotatably operates downwardly based on one side of the front or the rear thereof based on the roof portion.

Furthermore, a variable head lining apparatus according to yet another aspect of the present invention may include a roof portion formed with a rail structure including an upper side rail and a lower side rail, a fixing rod and a sliding rod for independently operating along the upper side rail and the lower side rail, respectively, a screen wound around the fixing rod and the sliding rod, and a display roll configured to be wound around the sliding rod, and the display roll is untied and unfolded downwardly from the sliding rod by the driving of a display motor.

The variable head lining apparatus of the present invention can implement the movable and extendable functions unlike the conventional one, further enhancing convenience by use of it corresponding to usability of a user.

Furthermore, it is possible to move the variable roof portion above the head top of a person according to movement of the seat, configured as a sun visor.

As such, it is possible for the variable roof portion to function as the lamp by itself when applying the screen while becoming flexible.

Furthermore, it is possible to increase usability of the utility in the vehicle internal by applying the display, and to extend the variable roof portion from the W/S glass to the rear glass to efficiently cover the vehicle internal, also configured as a cargo screen.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a variable head lining apparatus according to various exemplary embodiments of the present invention.

FIG. 2A and FIG. 2B are diagrams illustrating operations of the variable head lining apparatus according to the various exemplary embodiments of the present invention.

FIG. 3 is a diagram illustrating a variable head lining apparatus according to various exemplary embodiments of the present invention.

FIG. 4 is a diagram illustrating a portion of the variable head lining apparatus according to the various exemplary embodiments of the present invention.

FIG. 5A is an enlarged diagram of the portion A of FIG. 4, and FIG. 5B is an enlarged diagram of the portion B of FIG. 4.

FIG. 6 is a diagram illustrating an operating state of the variable head lining apparatus according to the various exemplary embodiments of the present invention.

FIG. 7 is a diagram illustrating a variable head lining apparatus according to various exemplary embodiments of the present invention.

FIG. 8A, FIG. 8B, and FIG. 8C are diagrams illustrating operating states of a variable head lining apparatus according to various exemplary embodiments of the present invention.

FIG. 9 is an enlarged diagram of a portion of the variable head lining apparatus according to the various exemplary embodiments of the present invention.

FIG. 10 is a diagram illustrating a variable head lining apparatus according to various exemplary embodiments of the present invention.

FIG. 11A, FIG. 11B, and FIG. 11C are diagrams illustrating operating states of a variable head lining apparatus according to various exemplary embodiments of the present invention.

FIG. 12 is an enlarged diagram of a portion of the variable head lining apparatus according to the various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

To fully understand the present invention, operational advantages of the present invention, and objects achieved by the practice of the present invention, reference may be made to the accompanying drawings exemplifying the exemplary embodiments of the present invention and the contents illustrated in the accompanying drawings.

In describing the exemplary embodiments of the present invention, a description of known or repeated descriptions that can unnecessarily obscure the subject matter of the present invention will be reduced or omitted.

A variable head lining apparatus of the present invention is an apparatus in which a roof portion is entirely composed of glass, an internal trim portion, etc., to be embedded in the ceiling of a vehicle, and a head lining having functional configuration such as an internal of a vehicle lamp is variously variable to implement various functions, allowing it to be implemented in a future vehicle such as an autonomous vehicle.

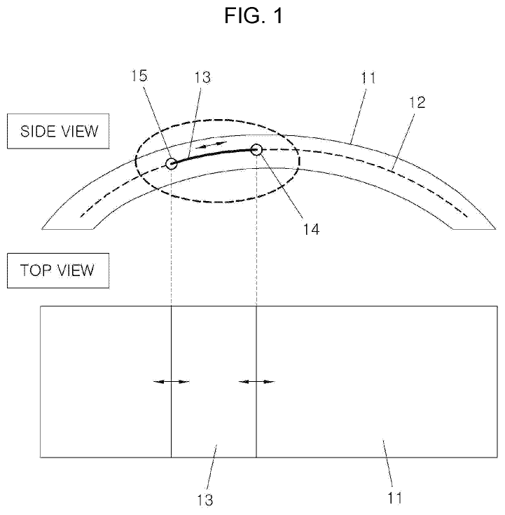

First, FIG. 1 is a diagram illustrating a variable head lining apparatus according to various exemplary embodiments of the present invention.

In the variable head lining apparatus of the various exemplary embodiments of the present invention, a variable roof portion 13 is provided inside a roof portion 11. The roof portion 11 may be composed of glass, an internal trim portion, etc.

The roof portion 11 can have a curved shape corresponding to the ceiling of the vehicle, and for example, the upper surface thereof can entirely be glass, and the lower surface thereof may be an opened configuration.

Therefore, the variable roof portion 13 is provided between the upper surface and the lower surface thereof, and as illustrated, is configured to be slidably moved from the front to the rear of the roof portion 11.

For the present purpose, the roof portion 11 is disposed with a rail structure 12, and for example, the rollers 14, 15 provided at the front end portion and the rear end portion of the variable roof portion 13, respectively, may be configured to be slidably moved on the rail structure 12. The roller may include two or more rollers, and furthermore, can also be configured to be slidably operated by other means for performing the same function as the roller.

As such, it has been illustrated that the rail structure 12 is configured inside the side surface of the roof portion 11 in the illustrated example, and furthermore, can also be configured inside the upper surface of the roof portion 11. In the instant case, the rollers 14, 15 may be provided on the upper surface of the variable roof portion 13.

Furthermore, a motor for driving the rollers 14, 15 is configured to be coupled with the rollers 14, 15, and a control portion for controlling the motor and an operating portion for operating it may be configured in the vehicle.

Meanwhile, the above-described variable roof portion is mounted in plural on the roof portion, and a user can control separately a plurality of rows in the vehicle, by use of the variable roof portion, respectively.

The motor, the control portion, and the operating portion are also provided in the following other embodiments, but the description thereof may be omitted for convenience in the following embodiments. As such, the description of the configuration of the same function may be reduced, and the applications according to the adoption of a plurality of variable roof parts, the rollers, etc. can also be applied to all the embodiments, which will be described later.

First, when recognizing, by the user, a drive command by use of the operating portion such as a button, speech recognition, or a touch panel, the control portion controls the motor to operate the variable roof portion 13.

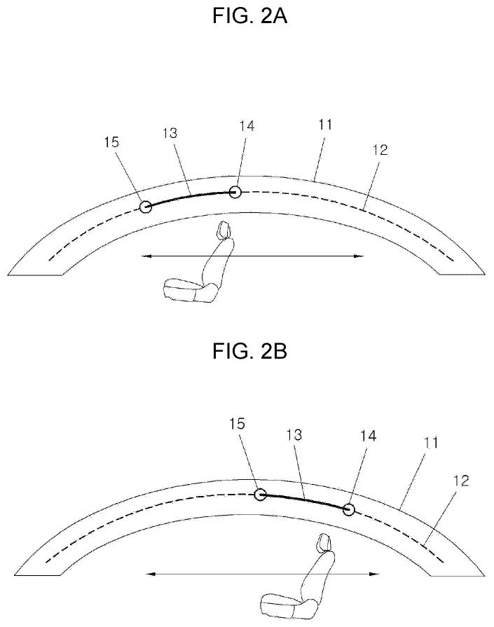

Furthermore, in an exemplary embodiment of the present invention, the driving of the motor may be driven according to the position of the seat as in FIG. 2A and FIG. 2B.

That is, the control portion can recognize the positional movement of the seat, and the control portion can drive the motor so that the variable roof portion 13 moves to the position corresponding to the position of the seat.

Therefore, the variable roof portion can implement the function of a sun visor and the lamp function through an internal lamp.

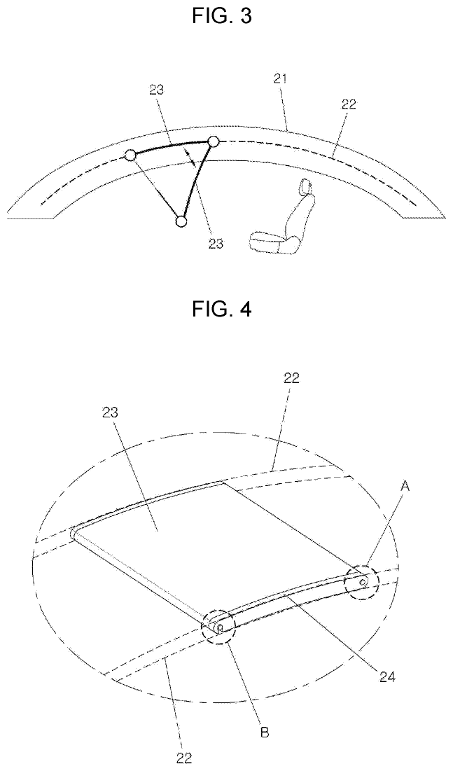

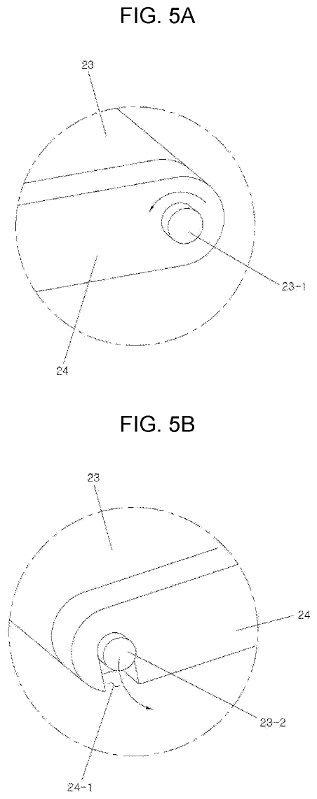

Next, FIG. 3 is a diagram illustrating a variable head lining apparatus according to various exemplary embodiments of the present invention.

A configuration of a roof portion 21 and a rail structure 22 in the various exemplary embodiments is the same as that in the various exemplary embodiments of FIG. 2.

In the various exemplary embodiments of the present invention, a variable roof portion is a display 23, and the display 23 may be provided inside the roof portion 21 to move between the front and the rear of the roof portion 21.

The display 23 is a device which is electrically connected to an image providing apparatus to display an input signal, and as illustrated, the display 23 is rotated toward the vehicle internal so that a driver can also enjoy or use the display 23 at a desired position.

A side roller bar 24 is provided on both sides surfaces of the display 23 for the movement on the rail structure 22 of the display 23, and the side roller bar 24 is moved along the rail structure 22 inside the roof portion 21.

Furthermore, the side roller bar 24 is slidably operated by a motor for driving it.

A hole for inserting a hinge shaft 23-1 of the display 23 is formed at one side of each side roller bar 24, and a groove 24-1 for inserting an insertion protrusion 23-2 of the display 23 is formed at the other side thereof

As illustrated, although it has been exemplified that the hole of the side roller bar 24 and the hinge shaft 23-1 of the display 23 are formed at the rear thereof, and the groove 24-1 of the side roller bar 24 and the insertion protrusion 23-2 of the display 23 are formed at the front thereof, the configuration of the front and the rear can also be reversely configured.

Therefore, when a hinge motor for driving the hinge shaft 23-1 is driven after the display 23 is disposed at the desired position, the insertion protrusion 23-2 of the display 23 escapes the groove 24-1 of the side roller bar 24 to be rotated downwardly.

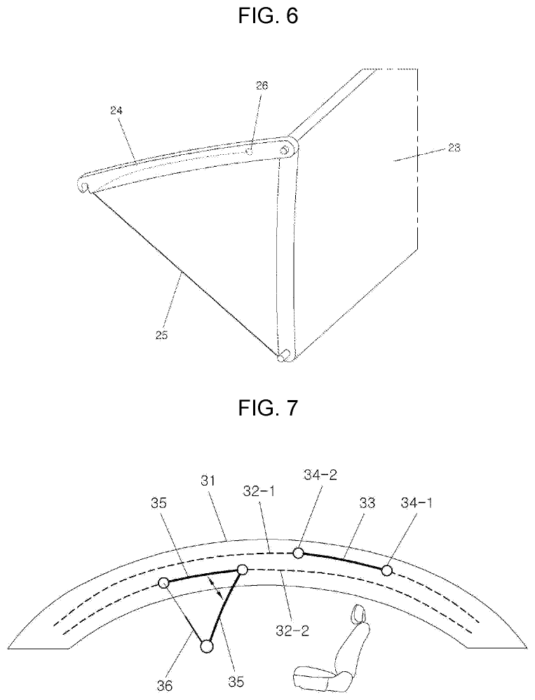

Furthermore, as in FIG. 6, a cable motor 26 is provided to set the rotation angle of the display 23, and a cable 25 connected between the cable motor 26 and the insertion protrusion 23-2 is coupled to pull the cable 25 by the driving of the cable motor 26, setting the rotation angle of the display 23.

Next, a variable head lining apparatus according to various exemplary embodiments of the present invention illustrated in FIG. 7 has a configuration with which the various exemplary embodiments in FIG. 1 and the various exemplary embodiments and FIG. 6 are coupled.

That is, a roof portion 31, a variable roof portion 33, the rollers 34-1, 34-2 coupled to the variable roof portion 33, a display 35, a side roller bar for movement of the display 35, a cable 36, etc. are the same as the configurations of the various exemplary embodiments of FIG. 1 and the various exemplary embodiments of FIG. 3 in the present invention, respectively.

However, a dual rail structure is provided to configure both the variable roof portion 33 and the display 35.

That is, an upper side rail 32-1 and a lower side rail 32-2 are configured inside the roof portion 31, and are configured so that the variable roof portion 33 is operated along one side rail, and the display 35 is operated along the other side rail.

As illustrated, it may be more preferable that the variable roof portion 33 is operated on the upper side rail 32-1, and the display 35 is operated on the lower side rail 32-2.

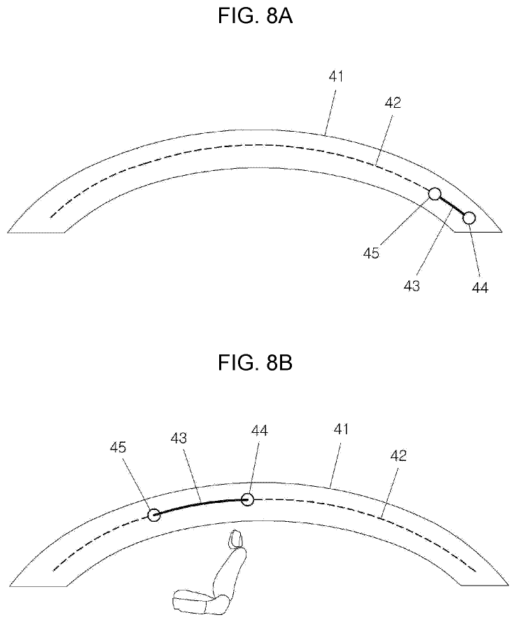

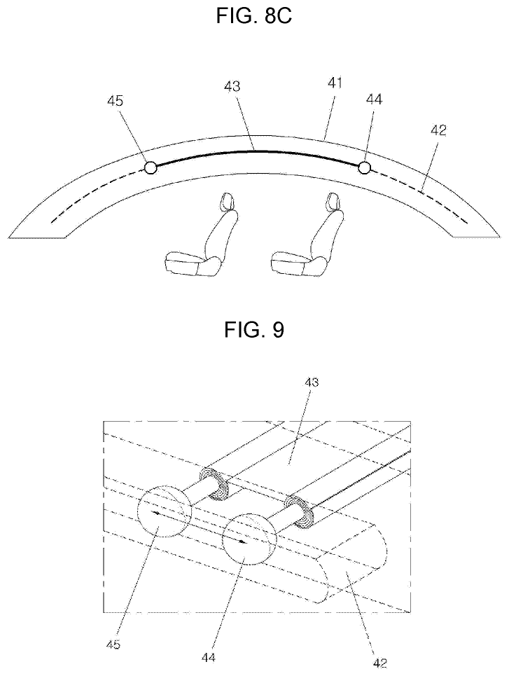

Next, FIG. 8A, FIG. 8B, and FIG. 8C are diagrams illustrating a variable head lining apparatus according to various exemplary embodiments of the present invention, and sequentially illustrate the operation thereof

A configuration of a roof portion 41 and a rail 42 inside the roof portion 41 is the same as that of the above-described embodiments.

In the various exemplary embodiments of the present invention, a screen 43 such as a fabric material instead of the above-described variable roof portion and the display is operated on the rail 42.

That is, a fixing rod 44 and a sliding rod 45 are coupled to the rail 42 to operate on the rail 42, and one end portion thereof and the other end portion of the screen 43 are coupled to the fixing rod 44 and the sliding rod 45, respectively.

The fixing rod 44 is not meant to be fixed on the rail 42, and the fixing rod 44 and the sliding rod 45 can both be operated on the rail 42, but the fixing rod 44 and the sliding rod 45 are both moved to set the positions, and then the fixing rod 44 is to fix the position in the case of unfolding the screen 43 and the sliding rod 45 is to slide to unfold the screen 43.

The screen 43 may be wound a plurality of times around the fixing rod 44 and the sliding rod 45, or can also be wound a plurality of times around only any one rod thereof

As described above, it is possible to implement the same effect as a panorama sunroof by the roll-type screen.

As such, a variable head lining apparatus according to various exemplary embodiments of the present invention illustrated in FIG. 10 has a configuration with which the various exemplary embodiments of FIG. 3 and the various exemplary embodiments of FIG. 8 are coupled.

That is, a roof portion 51 has a dual rail structure of an upper side rail 52-1 and a lower side rail 52-2, and is configured so that a screen 53 is operated by a fixing rod 54 and a sliding rod 55 on the upper side rail 52-1, and a display 56 is operated on the lower side rail 52-2.

Therefore, it is possible to utilize the function such as the panoramic sunroof and the display.

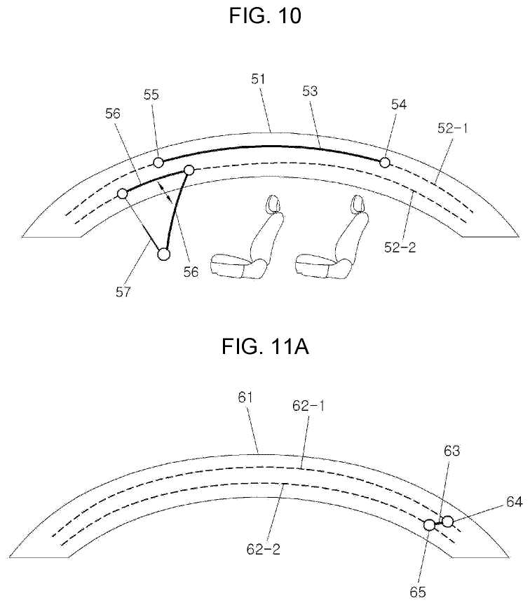

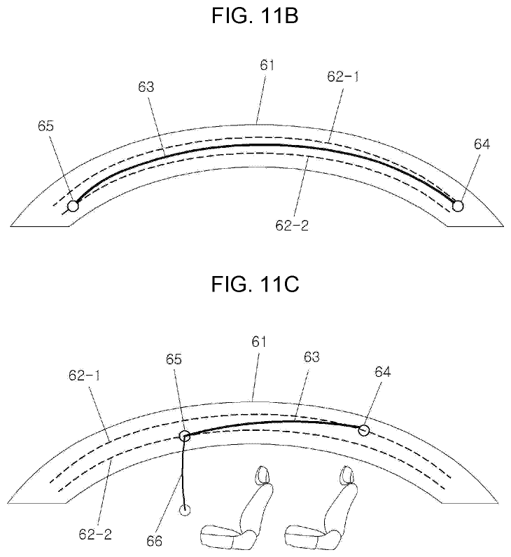

Next, FIG. 11A, FIG. 11B, and FIG. 11C are diagrams illustrating a variable head lining apparatus according to various exemplary embodiments of the present invention, and sequentially illustrate the operation thereof

A roof portion 61 and an upper side rail 62-1 and a lower side rail 62-2 inside the roof portion 61 are configured.

A screen 63, a fixing rod 64, and a sliding rod 65 as in the various exemplary embodiments are configured.

However, herein, the fixing rod 64 and the sliding rod 65 are configured on the rails of the different sides.

In the illustrated example, although it has been exemplified that the fixing rod 64 is operated on the upper side rail 62-1 and the sliding rod 65 is operated on the lower side rail 62-2, they may be reversely configured.

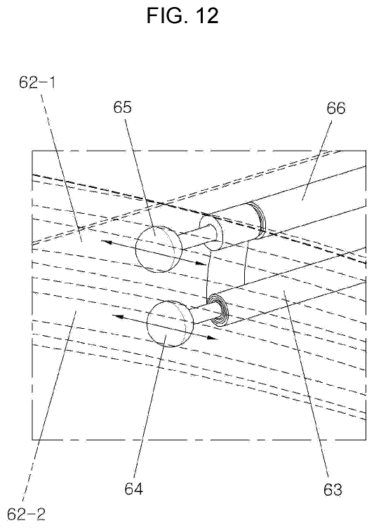

As illustrated in FIG. 12, the fixing rod 64 and the sliding rod 65 can move between the front and rear of the roof portion 61, and the screen 63 is configured to be wound between the fixing rod 64 and the sliding rod 65.

However, the screen 63 is not wound around the entire width of the sliding rod 65, but is wound around only the width corresponding to a portion of the side surface thereof.

As such, a display roll 66 is configured to be wound around the central side of the sliding rod 65, rather than the portion where the screen 63 has been wound around the sliding rod 65.

The display roll 66 is a flexible roll-type display which may be rolled-in, and the display roll 66 is untied from the sliding rod 65 by the driving of a separate display motor after the screen 63 has been disposed, implementing the shape as in FIG. 11C.

As described above, according to the exemplary embodiment of the present invention, it is possible to function as a cargo screen by the screen, and furthermore, to implement the roll-type display together.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A variable head lining apparatus, comprising:
a roof or side portion including a rail structure and entirely exposable to an internal of a vehicle; and
a variable roof portion configured to partially cover the roof portion by slidably operating along the rail structure.

2. The variable head lining apparatus of claim 1, further including:
a motor engaged to the variable roof portion and configured for driving the variable roof portion along the rail structure; and
a controller coupled to the motor and configured for controlling the motor.

3. The variable head lining apparatus of claim 2,
wherein the variable roof portion slidably operates by a roller mounted to the rail structure.

4. The variable head lining apparatus of claim 2,
wherein the controller controls the motor by interlocking with a positional movement of a seat by recognizing the positional movement of the seat in the vehicle.

5. The variable head lining apparatus of claim 4,
wherein the variable roof portion includes glass or an internal trim portion.

6. The variable head lining apparatus of claim 1,
wherein the variable roof portion includes a display configured for displaying an input signal provided from an image providing apparatus.

7. The variable head lining apparatus of claim 6,
wherein the display is configured to selectively rotate downwardly based on a front or a rear of the display based on the roof portion.

8. The variable head lining apparatus of claim 7, further including:
a hinge motor connected to a hinge shaft of the display and configured to drive the hinge shaft to be selectively engaged to a groove formed on a side roller bar of the display;
a cable connected to an end of the display and configured for limiting a rotation angle of the display; and
a cable motor engaged to the cable and configured for selectively driving the cable.

9. The variable head lining apparatus of claim 1, further including a display,
wherein the rail structure includes an upper side rail and a lower side rail,
wherein the display is configured for slidably operating along one of the upper side rail and the lower side rail, and displaying an input signal provided from an image providing apparatus, and
wherein the variable roof portion slidably operates along another of the upper side rail and the lower side rail.

10. The variable head lining apparatus of claim 9,
wherein the variable roof portion slidably operates by interlocking with a positional movement of a seat in a vehicle.

11. The variable head lining apparatus of claim 1,
wherein the variable roof portion is configured in a roll type, and is configured to extend an area of covering the roof portion by slidably operating along the rail structure.

12. A variable head lining apparatus, comprising:
a roof or side portion including a rail structure and exposable to an internal of a vehicle;
a fixing rod and a sliding rod slidably engaged to the rail structure for slidably operating along the rail structure; and
a screen engaged to the fixing rod and the sliding rod and configured to be selectively wound around the fixing rod and the sliding rod,
wherein the fixing rod and the sliding rod are operable independently.

13. The variable head lining apparatus of claim 12, further including a display,
wherein the rail structure includes an upper side rail and a lower side rail,
wherein the screen slidably operates along one of the upper side rail and the lower side rail, and
wherein the display is configured for slidably operating along another of the upper side rail and the lower side rail, and for displaying an input signal provided from an image providing apparatus.

14. The variable head lining apparatus of claim 13,
wherein the display rotatably operates downwardly based on a front or a rear thereof based on the roof portion.

15. A variable head lining apparatus, comprising:
a roof or side portion formed with a rail structure including an upper side rail and a lower side rail;
a fixing rod and a sliding rod for independently operating along the upper side rail and the lower side rail, respectively;
a screen engaged to the fixing rod and the sliding rod and selectively wound around the fixing rod and the sliding rod; and
a display roll configured to be wound around the sliding rod,
wherein the display roll is untied and unfolded downwardly from the sliding rod by driving of a display motor engaged to the display roll.
